(19) United States
(12) Patent Application Publication
(10) Pub. No.: US 2010/0171736 A1
(43) Pub. Date: Jul. 8, 2010

(54) Plasma display panel and associated methods

(76) Inventors: Ju-Gon Seok, Suwon-si (KR); Woo-Joon Chung, Suwon-si (KR); Tae-Jun Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/654,120

(22) Filed: Dec. 10, 2009

(30) Foreign Application Priority Data
Jan. 6, 2009 (KR) 10-2009-0000740

(51) Int. Cl. G09G 5/00; H01J 17/49; H01J 9/24

(52) U.S. Cl. 345/213; 313/582; 445/24

(57) ABSTRACT

A plasma display panel includes electrodes repeatedly disposed on a first substrate in an order of a sustain electrode, a scan electrode, a scan electrode and a sustain electrode, first barrier ribs disposed to overlap the sustain electrodes, and second barrier ribs disposed to overlap the scan electrodes and having a lower height than the first barrier ribs, wherein a space between the first barrier ribs and the second barrier ribs forms a main discharge space, a space between adjacent first barrier ribs forms an auxiliary discharge space, and the scan electrodes are formed to protrude to the auxiliary discharge space.

### BACKGROUND OF THE INVENTION

1. Field of the Invention

Embodiments relate to a plasma display panel. More particularly, embodiments relate to a plasma display panel and associated methods capable of reducing or preventing error discharge and/or address discharge delay.

2. Description of the Related Art

A plasma display panel (hereinafter, referred to as a ‘PDP’) displays an image by exciting phosphors using ultraviolet light generated during the discharge of an inert mixed gas. This PDP can be easily made thin and large, and also provide greatly increased image quality due to recent developments in the relevant technology.

The PDP is driven by dividing one frame into various subfields having different emission frequencies in order to implement a gray scale of an image. Each subfield is divided into a reset period where cells are initialized, an address period where a cell to be turned on is selected, and a sustain period where a gray scale is implemented according to a discharge frequency.

During the reset period, ramp pulses are supplied to scan electrodes to cause reset discharge within discharge cells. Owing to such reset discharge, wall charges required in address discharge remain evenly within the discharge cells.

During the address period, data pulses are supplied to address electrodes simultaneously supplying scan pulses sequentially to the scan electrodes. At this time, voltage differences between the data pulses and the scan pulses are added to wall voltages of the wall charges of the discharge cells formed during the reset period, generating an address discharge. Predetermined wall charges are generated within the discharge cells due to the address discharge described above.

During the sustain period, sustain pulses are supplied alternately to the scan electrodes and sustain electrodes. The wall voltages within the discharge cells selected by the address discharge are added to voltages of the sustain pulses, thereby generating surface discharge type sustain discharge whenever the sustain pulses are applied.

In the PDP as describe above, delay of the address discharge increases over time. This increase in delay results in an increase in the amount of time assigned to the address period, resulting in less time being available for the sustain discharge to be performed. Another problem also arises in that since the address discharge delay causes erroneous discharge (mis-discharge), a desired image cannot be displayed.

### SUMMARY OF THE INVENTION

Embodiments are therefore directed to providing a PDP and associated methods that substantially overcome one or more of the problems and disadvantages of the related art.

It is a feature of an embodiment to provide a PDP and associated methods capable of reducing or preventing error discharge.

It is another feature of an embodiment to provide a PDP and associated methods capable of minimizing address discharge delay.

It is yet another feature of an embodiment to provide a PDP capable of providing a shortened address period.

At least one of the above and other features and advantages may be realized by providing a PDP, including electrodes repeatedly disposed on a first substrate in an order of a sustain electrode, a scan electrode, a scan electrode, and a sustain electrode, first barrier ribs disposed to overlap the sustain electrodes, and second barrier ribs disposed to overlap the scan electrodes and having a lower height than the first barrier ribs, wherein a space between the first barrier ribs and the second barrier ribs forms a main discharge space, a space between adjacent first barrier ribs forms an auxiliary discharge space, and the scan electrodes protrude into the auxiliary discharge space.

Each scan electrode may include a first bus electrode disposed to overlap the second barrier ribs and a first transparent electrode disposed to protrude into the main discharge space and the auxiliary discharge space.

Each sustain electrode may include a second bus electrode disposed to overlap the first barrier ribs and a second transparent electrode disposed to protrude into the main discharge space.

The first transparent electrode may be wider than the second transparent electrode.

The second barrier ribs may have a height of about 70% or less than that of the first barrier ribs.

The first barrier ribs may extend fully between the first substrate and a second substrate opposite the first substrate.

Adjacent second barrier ribs may be further apart than adjacent first barrier ribs.

The PDP may further include a scan driver that supplies a driving waveform to the scan electrodes and a sustain driver that supplies a driving waveform to the sustain electrodes.

The scan driver may supply scan signals sequentially to the scan electrodes during an address period.

During the address period, the scan driver may supply a first sustain pulse to an i^{th} (i is 1, 3, 5, etc.) scan electrode after supplying scan signals and may supply only the scan signals to an i+1^{st} scan electrode.

During the address period, the sustain driver may supply a second sustain pulse to an i^{th} sustain electrode, the second sustain pulse alternating with the first sustain pulse.

The scan driver and the sustain driver may alternately supply a sustain pulse during a sustain period.

The first and second sustain pulses supplied during the address period may have a voltage equivalent to or lower than the sustain pulse supplied during the sustain period.

The PDP may further include address electrodes on a second substrate in a direction intersecting the scan electrodes and the sustain electrodes, and an address driver that supplies a driving waveform to the address electrodes.

The address driver may supply a data pulse to the address electrodes during an address period, the data pulse synchronizing with the scan signals sequentially applied to the scan electrodes during the address period.

The sustain driver may supply a same driving waveform to all the sustain electrodes.

At least one of the above and other features and advantages may be realized by providing a method of driving a PDP having electrodes in order of a sustain electrode, a scan electrode, a scan electrode, and a sustain electrode, the method including, during an address period, generating an address discharge in a selected discharge cell, generating priming charged particles in an auxiliary space adjacent the selected discharge cell, and supplying the priming charged particles to discharge cells adjacent the auxiliary discharge space.

During the address period, the method may include supplying a positive first sustain pulse to an i^{th} (i is 1, 3, 5, etc.) scan electrode after supplying scan signals, and supplying only the scan signals to an i+1^{st} scan electrode.

The first pulse supplied during the address period may have a voltage equivalent to or lower than a sustain pulse supplied during a sustain period.

At least one of the above and other features and advantages may be realized by providing a method of forming a PDP, including repeatedly providing electrodes on a first substrate in an order of a sustain electrode, a scan electrode, a scan electrode, and a sustain electrode, providing first barrier ribs to overlap the sustain electrodes, and providing second barrier ribs having a lower height than the first barrier ribs to overlap the scan electrodes, wherein a space between the first barrier ribs and the second barrier ribs forms a main discharge space, a space between adjacent first barrier ribs forms an auxiliary discharge space, and the scan electrodes protrude into the auxiliary discharge space.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a PDP according to an embodiment of the present invention;

FIG. 2 illustrates a cross-sectional view of a PDP of FIG. 1;

FIG. 3 illustrates a waveform view of a method of driving a PDP according to an embodiment of the present invention;

FIGS. 4A to 4D illustrate wall charge distributions in a discharge cell during application of the driving waveform of FIG. 3;

FIGS. 5A to 5C illustrate wall charge distributions in an auxiliary discharge space during application of the driving waveform of FIG. 3;

FIG. 6 illustrates a method of driving a PDP according to another embodiment of the present invention; and

FIG. 7 illustrates a graph of an address discharge delay depending on whether auxiliary discharge occurs.

### DETAILED DESCRIPTION OF THE INVENTION

Korean Patent Application No. 10-2009-0000740, filed on Jan. 6, 2009, in the Korean Intellectual Property Office, and entitled: “Plasma Display Panel,” is

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

In addition, “wall charges” described herein mean charges formed and accumulated on a wall, e.g., a dielectric layer, close to an electrode of a discharge cell. A wall charge may be described as being “formed on” or “accumulated on” the electrode, although the wall charges may not actually touch the electrode. Further, a “wall voltage” means a potential difference formed on the wall of the discharge cell by the wall charge.

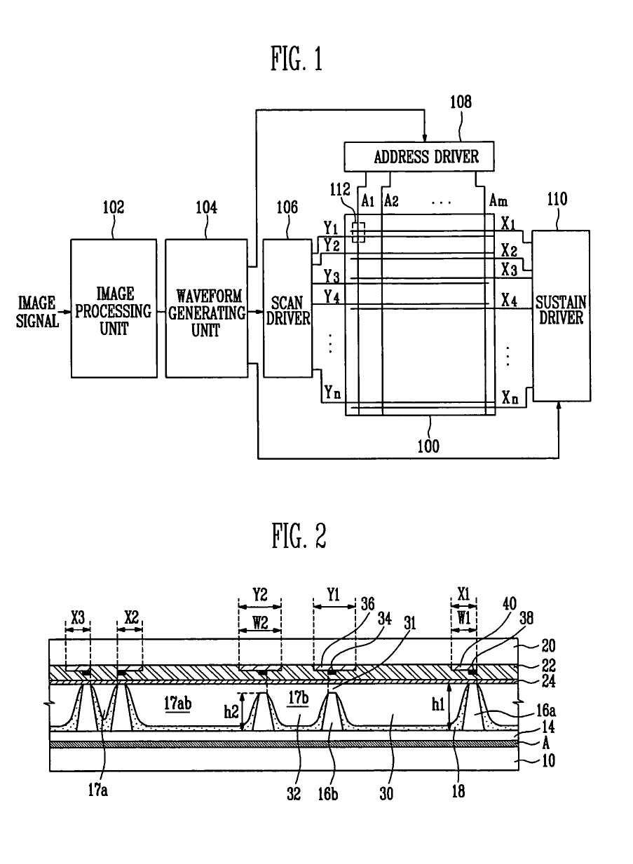

Hereinafter, embodiments will be described in more detail with reference to FIGS. 1 to 7 so that a person having ordinary skill in the art to which embodiments pertain can readily carry out these embodiments.

FIG. 1 illustrates a plasma display panel (“PDP”) according to an embodiment of the present invention. Referring to FIG. 1, the PDP may include a panel 100, an address driver 108, a scan driver 106, a sustain driver 110, a waveform generating unit 104, and an image processing unit 102.

The image processing unit 102 may receive an analog image signal from the outside and may convert the analog image signal into a digital image signal. The image processing unit 102 may also generate a vertical synchronization signal, a horizontal synchronization signal, a clock signal, etc., and may supply them to the waveform generating unit 104.

The waveform generating unit 104 may receive the digital image signal, the vertical synchronization signal, the horizontal synchronization signal, and the clock signal. The waveform generating unit 104 may divide the digital image signal into subfields and supply the divided image signal to the address driver 108. The waveform generating unit 104 may also generate control signal corresponding to the vertical synchronization signal, the horizontal synchronization signal, and the clock signal, and may supply the generated control signals to the scan driver 106, the address driver 108, and the sustain driver 110.

The address driver 108 may generate data signals corresponding to the image signal and control signals supplied thereto, and may supply the generated data signals to address electrodes A1 to Am during an address period of the subfield.

The scan driver 106 may generate scan signals corresponding to the control signals supplied thereto and may supply the generated scan signals sequentially to scan electrodes Y1 to Yn during the address period of the subfield. The scan driver 106 may also supply ramp pulses to the scan electrodes Y1 to Yn during a reset period and sustain pulses thereto during a sustain period.

The sustain driver 110 may supply sustain pulses to sustain electrodes X1 to Xn in order to alternate with the sustain pulses supplied to the scan electrodes Y1 to Yn during the sustain period, corresponding to the control signals supplied thereto.

A discharge cell 112 may be positioned at the intersection of the scan electrode Y, the sustain electrode X, and the address electrode A. The discharge cell 112 may generate sustain discharge corresponding to the driving waveform supplied to the scan electrode Y, the sustain electrode X, and the address electrode A, and may display a predetermined image corresponding to the sustain discharge frequency. As illustrated in FIG. 1, electrodes may be repeatedly disposed as a sustain electrode X1, a scan electrode Y1, a scan electrode Y2, and a sustain electrode X2 order.

FIG. 2 illustrates a cross-sectional view of a PDP of FIG. 1. Referring to FIG. 2, the PDP may include an upper substrate 20, a lower substrate 10, scan electrodes Y and sustain electrodes X formed on a rear surface of the upper substrate 20, and an address electrode A formed on the lower substrate 10.

Each of the scan electrodes Y may include a transparent electrode 36 and a bus electrode 34. The bus electrode 34 may have a line width smaller than that of the transparent electrode 36 and may be formed on a rear surface of the transparent electrode 36. The sustain electrodes X may include a transparent electrode 40 and a bus electrode 38. The bus electrode 38 may have a line width smaller than that of the transparent electrode 40 and may be formed on an edge of the transparent electrode 40.

The transparent electrodes 36 and 40 may be formed of transparent material, e.g., Indium-Tin-Oxide (ITO). The bus electrodes 34 and 38 may be formed of a highly conductive material, e.g., metal, such as chrome (Cr), on the rear surface of the transparent electrodes 36 and 40. Such bus electrodes 34 and 38 may serve to reduce a voltage drop of the transparent electrodes 36 and 40, which have a high resistance.

An upper dielectric layer 22 and a passivation film 24 may be sequentially stacked on the upper substrate 20 on which the scan electrodes Y and the sustain electrodes X are formed to be parallel to each other. Wall charges generated at the time of plasma discharge may be accumulated on the upper dielectric layer 22. The passivation film 24 may reduce or prevent damage to the upper dielectric layer 22 during plasma discharge and may further enhance emission efficiency. Magnesium oxide (MgO) may be used as the passivation film 24.

A lower dielectric layer 14 and barrier ribs 16a and 16b may be formed on the lower substrate 10 on which the address electrode A is formed. A phosphor layer 18 may be provided on surfaces of the lower dielectric layer 14 and the barrier ribs 16a and 16b.

The phosphor layer 18 may be excited by ultraviolet (UV) light generated during plasma discharge to generate visible light of a corresponding color, e.g., red, green, or blue. An inert mixture gas maybe provided in a discharge space provided between the upper/lower substrates 10 and 20 and the barrier ribs 16a and 16.

The barrier ribs 16a and 16b may prevent the UV and visible light generated by the discharge from leaking into adjacent discharge cells. Such barrier ribs 16a and 16b may overlap the bus electrodes 34 and 38 included in each of the scan electrodes Y and sustain electrodes X. In other words, the first barrier rib 16a may overlap the bus electrode 38 included in the sustain electrodes X and the second barrier rib 16b may overlap the bus electrode 34 included in the scan electrode Y.

A space 17ab between the first barrier rib 16a and the second barrier rib 16b may serve as a main discharge space 30, i.e., a discharge cell. A space 17b between adjacent second barrier ribs 16b may serve as an auxiliary discharge space 32. A space 17a between adjacent first barrier ribs 16a may be smaller than the space 17b.

The transparent electrode 38 of the sustain electrodes X may have a first width W1 that protrudes only into the main discharge space 30, i.e., where sustain discharge occurs. However, the transparent electrode 36 of the scan electrodes Y may have a second width W2, which is wider than the first width W1, and may protrude into both the main discharge space 30 and the auxiliary discharge space 32, i.e., where sustain discharge does not occur. In this case, address discharge delay may be minimized due to an auxiliary discharge generated in the auxiliary discharge space 32 during the address period.

More specifically, predetermined priming charged particles may be generated by auxiliary discharge generated from the auxiliary discharge space 32 during the address period. Then, address discharge may be easily generated from the main discharge space 30 due to the priming charged particles. While the address discharge delay still actually increases in the main discharge space 30 as time elapses, in the auxiliary discharge space, discharge delay does not increase with time. Therefore, the address discharge delay in the main discharge space 30 may be reduced due to the priming charged particles generated in the auxiliary discharge space 32 during the address period.

When a height h2 of the second barrier rib 16b is set to be less than an entire space between the first and second substrates 10 and 20, there is a predetermined space 31 between the first passivation film 24 and the second barrier rib 16b. Thus, the priming charged particles generated in the auxiliary discharge space 32 may be supplied to the main discharge space 30 through the predetermined space 31.

In this respect, configurations of the first and second barrier ribs 16a and 16b may be different. For example, a height h1 of the first barrier rib 16a may be greater than the height h2 of the second barrier rib 16b, e.g., the height h2 of the second barrier rib 16b may be equal to or less than about 70% of the height h1 of the first barrier rib 16a. As illustrated in FIG. 2, the first barrier rib 16a may extend completely between the first and second substrates 10 and 20. Further, as noted above, the space 17b between adjacent second barrier ribs 16b may be greater than the space 17a between adjacent first barrier ribs 16a. Indeed, adjacent barrier ribs 16a may be integrally formed as a single barrier rib, i.e., the space 17a may be zero.

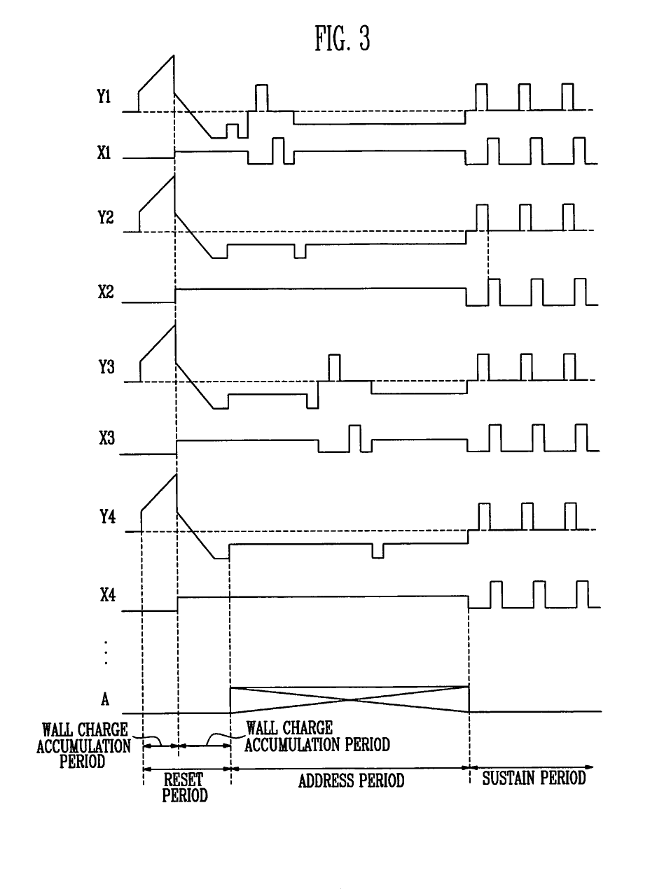

FIG. 3 illustrates a waveform view of a driving method of a PDP according to an embodiment of the present invention. In FIG. 3, one subfield of a plurality of subfields included in one frame will be shown for convenience of explanation. Driving waveforms supplied during the reset period and the sustain period are shown only as an example and embodiments are not limited thereto.

Referring to FIG. 3, the subfield of the PDP according to the present invention may be driven by being divided into a reset period, an address period, and a sustain period.

During a wall charge accumulation period of the reset period, rising ramp pulses having a predetermined slope may be supplied to the scan electrodes Y. When the rising ramp pulses are supplied to the scan electrodes Y, a micro discharge is generated within discharge cells 112 and wall charges are accumulated within the discharge cells 112 due to the micro discharge.

During a wall charge distribution period of the reset period, falling ramp pulses having a predetermined slope may be supplied to the scan electrodes Y and a predetermined voltage may be applied to the sustain electrodes X. When the falling ramp pulses are supplied to the scan electrodes Y, a micro discharge is generated within the discharge cells 112 and a portion of the wall charges formed during the wall charge accumulation period is reduced due to the micro discharge. In other words, during the wall charge distribution period, the amount of the wall charges accumulated in the discharge cells 112 during the wall charge accumulation period may be reduced, thereby preventing excessively strong discharge from being generated during the address period.

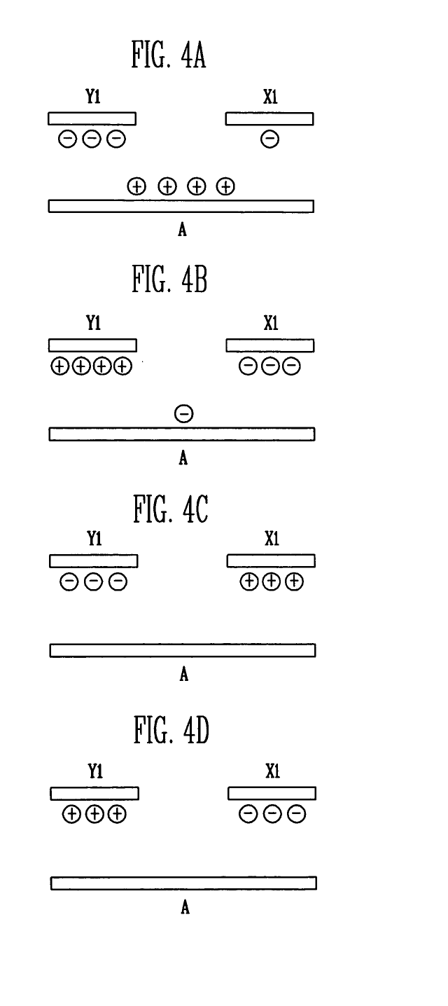

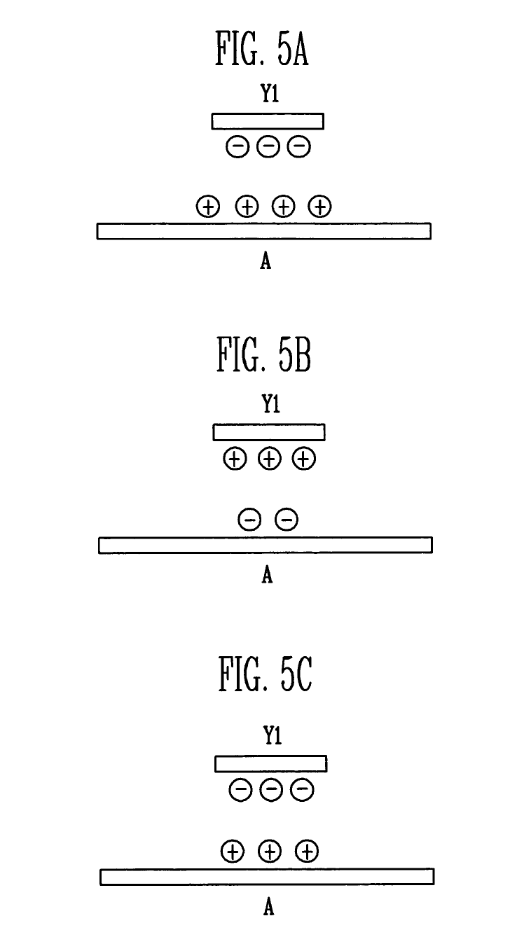

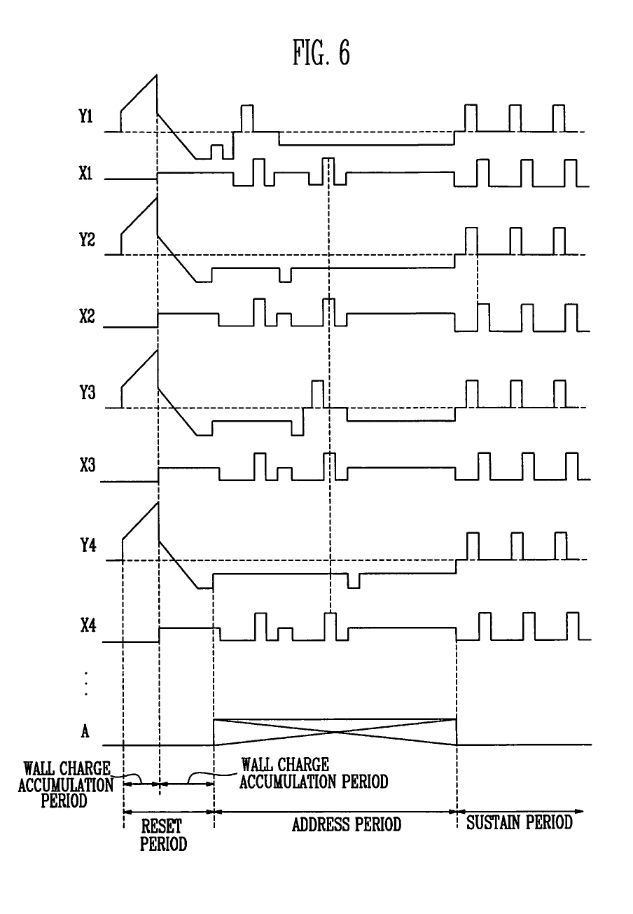

Wall charge distributions during application of the driving waveform of FIG. 3 are illustrated in FIGS. 4A to 5C. In particular, FIGS. 4A to 4D illustrate wall charge distributions in the main discharge space 30 and FIGS. 5A to 5C illustrate wall charge distributions in the auxiliary discharge space 32

As shown in FIG. 4A, wall charges may be formed on a first scan electrode Y1, a first sustain electrode X1, and an address electrode A positioned in the discharge cell 112, after the reset period. For convenience of explanation, the first scan electrode Y1 and the first sustain electrode X1 will be described. In the same manner, wall charges as shown in FIG. 5A may be formed on the first scan electrode Y1 and the address electrode A positioned in the auxiliary discharge space 32.

During the address period, scan signals may be supplied sequentially to the first scan electrode Y1 to an n scan electrode Yn, and data signals in synchronization with the scan signals may be supplied to the address electrodes A.

When the scan signal is supplied to the first scan electrode Y1 and the data signals are supplied to the address electrodes A, an address discharge is generated in the discharge cell 112. In practice, the address discharge is controlled depending on whether the data signal is supplied to each of the discharge cells. As shown in FIG. 4B, when the data signal is supplied to the discharge cell, wall charges of positive polarity are formed on the first scan electrode Y1 and wall charges of negative polarity are formed on the first sustain electrode X1 and the address electrode A.

Meanwhile, when the scan signal is supplied to the first scan electrode Y1 and the data signals are supplied to the address electrodes A, an auxiliary discharge may be generated from an auxiliary discharge space 32. Priming charged particles generated due to the auxiliary discharge may be supplied to the adjacent discharge cells 112 to allow an address discharged to be readily generated. As shown in FIG. 5B, when the auxiliary discharge is generated, wall charges of positive polarity are formed on the first scan electrode Y1 and wall charges of negative polarity are formed on the address electrode A.

After the scan signal is supplied to the first scan electrode Y1, a first sustain pulse may be supplied to the first scan electrode Y1. A second sustain pulse may be supplied to the first sustain electrode X1 to alternate with the first sustain pulse supplied to the first scan electrode Y1.

When the first sustain pulse is supplied to the first scan electrode Y1, sustain discharge is generated between the first scan electrode Y1 and the first sustain electrode X1 on the discharge cell 112 where the address discharge is generated. In this case, as shown in FIG. 4C, wall charges of negative polarity are formed on the first scan electrode Y1 and wall charges of positive polarity are formed on the first sustain electrode X1. When the second sustain pulse is supplied to the first sustain electrode X1, as shown in FIG. 4D, wall charges of positive polarity are formed on the first scan electrode Y1 and wall charges of negative polarity are formed on the first sustain electrode X1 due to the sustain discharge.

Meanwhile, when the sustain pulse is supplied to the first scan electrode Y1, a discharge is also generated in the auxiliary discharge space 32. More specifically, as shown in FIG. 5B, the wall charges of positive polarity formed on the first scan electrode Y1 are added to the voltage of the sustain pulse, thereby generating a discharge between the first scan electrode Y1 and the address electrode A. In this case, as shown in FIG. 5C, wall charges of negative polarity are formed on the first scan electrode Y1 and wall charges of positive polarity are formed on the address electrode A.

Thereafter, the scan signal may be supplied to a second scan electrode Y2, and data signals may be supplied to the address electrodes A. Then, an address discharge is generated from the discharge cell 112 supplied with the data signals. An auxiliary discharge is generated from the auxiliary discharge space 32 in which the second scan electrode Y2 is included.

More specifically, the auxiliary discharge space 32 in which the second scan electrode Y2 is included is the same space as the auxiliary discharge space 32 in which the first scan electrode Y1 is included. Here, as shown in FIG. 5C, wall charges of positive polarity are formed on the address electrode A formed in the auxiliary discharge space 32 due to the discharge by the sustain pulse supplied to the first scan electrode Y1. Therefore, when the scan signal is supplied to the second scan electrode Y2, the auxiliary discharge may be stably generated between the address electrode A and the second scan electrode Y2. The priming charged particles generated due to the auxiliary discharge allows the address discharge to be easily generated in the discharge cell 112 in which the second scan electrode Y2 is included.

Thereafter, the process as described above may be repeated as the scan signals are supplied sequentially to a third to an n^{th} scan line (Y3 to Yn). Here, after the scan signal is supplied, the first sustain pulse maybe supplied to i^{th} (i is 1, 3, 5, . . . ) scan lines Yi, thereby forming wall charges of positive polarity on the address electrode A in the auxiliary discharge space 32. The second sustain pulse may be supplied to the i^{th} scan electrodes Xi to alternate with the first sustain pulse supplied to the i^{th} scan lines Yi. Also, after the scan signal is supplied, the first sustain pulse may not be supplied to i+1^{st} scan lines Yi+1.

More specifically, the i^{th} scan line Yi and the i+1^{st} scan line Yi+1 may supply the priming charged particles to adjacent discharge cells 112 sharing the auxiliary discharge space 32. Therefore, after the scan signal is supplied, the first sustain pulse is supplied to the i^{th} scan line Yi so that the auxiliary discharge is stably generated from the auxiliary discharge space 32 when the scan signal is supplied to the i+1^{st} scan line Yi+1. However, there is no need to generate further auxiliary discharge in the auxiliary discharge space 32 after the scan signal is supplied to the i+1^{st} scan line Yi+1. Therefore, the first sustain pulse is not supplied to the i+1^{st} scan line Yi+1.

The first and second sustain pulses supplied during the address period may have a voltage equivalent to or lower than the sustain pulse supplied during the sustain period. In other words, the voltage value of the first and second sustain pulses may be controlled so that relatively weak discharge is generated during the address period.

During the sustain period, the sustain pulses that have sustain voltage may be alternately supplied to the scan lines and sustain electrodes to allow the sustain discharge to be generated from the discharge cell 112 selected due to the address discharge. An image having a predetermined brightness may be displayed on a panel corresponding to the frequency with which the sustain discharge is generated.

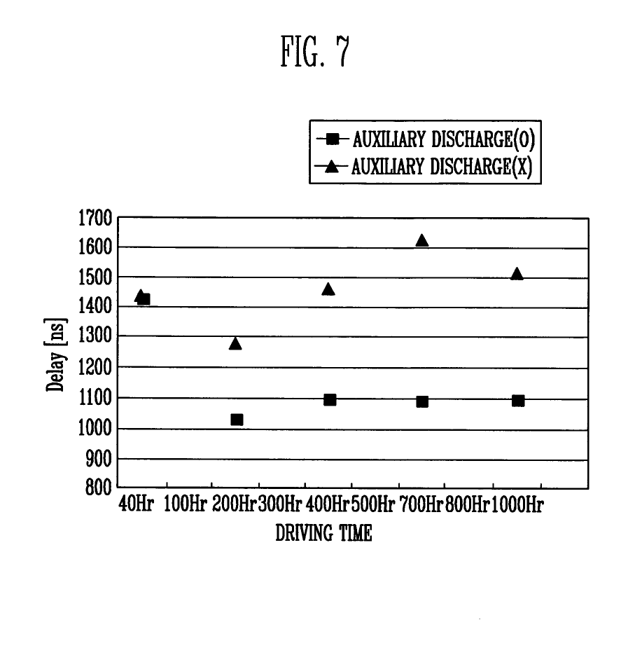

FIG. 6 illustrates a driving method of a PDP according to another embodiment of the present invention. When explaining FIG. 6, the detailed description on the same portions as FIG. 3 will not be repeated.

Referring to FIG. 6, waveforms having the same shape may be supplied to sustain electrodes X1 to Xn. In other words, a second sustain pulse may be simultaneously supplied to alternate with a first sustain pulse supplied to an i^{th} scan electrode Yi during an address period. Although the sustain pulse is supplied simultaneously to the scan electrodes X1 to Xn, a discharge is generated only in a discharge cell 112 where a discharge is generated due to the i^{th} scan electrode Yi and the discharge is not generated in discharge cells other than the discharge cell 112. In other words, as shown in FIG. 4A, wall charges of negative polarity are formed on the sustain electrodes X1 to Xn during the reset period and thereby, a necessary discharge is not generated in the discharge cells where the sustain discharge is not generated.

Meanwhile, if the same driving waveform is supplied to the scan electrodes X1 to Xn, as shown in FIG. 6, the constitution of the sustain driver 110 may be simplified, thereby reducing manufacturing cost while simultaneously improving reliability.

FIG. 7 illustrates a graph of address discharge delay depending on whether auxiliary discharge occurs.

Referring to FIG. 7, when the auxiliary discharge is generated, priming charged particles are supplied so that address discharge delay is set to be shorter than a case where the auxiliary discharge is not generated. Actually, when the auxiliary discharge is generated, the address discharge delay is shortened by 400 ns to 500 ns compared to the case where the auxiliary discharge is not generated.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
electrodes repeatedly disposed on a first substrate in an order of a sustain electrode, a scan electrode, a scan electrode, and a sustain electrode;
first barrier ribs disposed to overlap the sustain electrodes; and
second barrier ribs disposed to overlap the scan electrodes and having a lower height than the first barrier ribs,
wherein a space between the first barrier ribs and the second barrier ribs forms a main discharge space, a space between adjacent first barrier ribs forms an auxiliary discharge space, and the scan electrodes protrude into the auxiliary discharge space.

2. The plasma display panel as claimed in claim 1, wherein each scan electrode comprises:
a first bus electrode disposed to overlap the second barrier ribs; and
a first transparent electrode disposed to protrude into the main discharge space and the auxiliary discharge space.

3. The plasma display panel as claimed in claim 2, wherein each sustain electrode comprises:
a second bus electrode disposed to overlap the first barrier ribs; and
a second transparent electrode disposed to protrude into the main discharge space.

4. The plasma display panel as claimed in claim 3, wherein the first transparent electrode is wider than the second transparent electrode.

5. The plasma display panel as claimed in claim 1, wherein the second barrier ribs have a height of about 70% or less than that of the first barrier ribs.

6. The plasma display panel as claimed in claim 1, wherein the first barrier ribs extend fully between the first substrate and a face of a second substrate opposite the first substrate.

7. The plasma display panel as claimed in claim 1, wherein adjacent second barrier ribs are further apart than adjacent first barrier ribs.

8. The plasma display panel as claimed in claim 1, further comprising:
a scan driver that supplies a driving waveform to the scan electrodes; and
a sustain driver that supplies a driving waveform to the sustain electrodes.

9. The plasma display panel as claimed in claim 8, wherein the scan driver supplies scan signals sequentially to the scan electrodes during an address period.

10. The plasma display panel as claimed in claim 9, wherein, during the address period, the scan driver supplies a positive first sustain pulse to an i^{th} (i is 1, 3, 5, etc.) scan electrode after supplying scan signals, and supplies only the scan signals to an i+1^{st} scan electrode.

11. The plasma display panel as claimed in claim 10, wherein, during the address period, the sustain driver supplies a second sustain pulse to an i^{th} sustain electrode, the second sustain pulse alternating with the first sustain pulse.

12. The plasma display panel as claimed in claim 11, wherein the scan driver and the sustain driver alternately supply a sustain pulse during a sustain period.

13. The plasma display panel as claimed in claim 12, wherein the first and second sustain pulses supplied during the address period have a voltage equivalent to or lower than the sustain pulse supplied during the sustain period.

14. The plasma display panel as claimed in claim 8, further comprising:
address electrodes on a second substrate in a direction intersecting the scan electrodes and the sustain electrodes; and
an address driver that supplies a driving waveform to the address electrodes

15. The plasma display panel as claimed in claim 14, wherein the address driver supplies a data pulse to the address electrodes during an address period, the data pulse synchronizing with the scan signals sequentially applied to the scan electrodes during the address period.

16. The plasma display panel as claimed in claim 8, wherein the sustain driver supplies a same driving waveform to all the sustain electrodes.

17. A method of driving a plasma display panel having electrodes in order of a sustain electrode, a scan electrode, a scan electrode, and a sustain electrode, the method including, during an address period:
generating an address discharge in a selected discharge cell;
generating priming charged particles in an auxiliary space adjacent the selected discharge cell; and
supplying the priming charged particles to discharge cells adjacent the auxiliary discharge space.

18. The method as claimed in claim 17, wherein, during the address period, supplying a first sustain pulse to an i^{th} (i is 1, 3, 5, etc.) scan electrode after supplying scan signals, and supplying only the scan signals to an i+1^{st} scan electrode.

19. The plasma display panel as claimed in claim 18, wherein the first pulse supplied during the address period has a voltage equivalent to or lower than a sustain pulse supplied during a sustain period.

20. A method of forming a plasma display panel, comprising:
repeatedly providing electrodes on a first substrate in an order of a sustain electrode, a scan electrode, a scan electrode, and a sustain electrode;
providing first barrier ribs to overlap the sustain electrodes; and
providing second barrier ribs having a lower height than the first barrier ribs to overlap the scan electrodes,
wherein a space between the first barrier ribs and the second barrier ribs forms a main discharge space, a space between adjacent first barrier ribs forms an auxiliary discharge space, and the scan electrodes protrude into the auxiliary discharge space.
